(19) United States
(12) Patent Application Publication
(10) Pub. No.: US 2010/0052916 A1
(43) Pub. Date: Mar. 4, 2010

(54) IDENTIFICATION BAND WITH SECURED ASSOCIATION TO WEARER

(75) Inventors: David Canora, Winter Garden, FL (US); Andy Schwalb, Mt.Dora, FL (US); Eric Jacobson, Glendale, CA (US); Jim Macphee, Clermont, FL (US); Kevin Rice, Altadena, CA (US); Dan Soto, Winter Garden, FL (US); David Worrall, Clermont, FL (US); Frank Farro, CELEBRATION, FL (US); John Padgett, Clermont, FL (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC

(21) Appl. No.: 12/231,740

(22) Filed: Sep. 4, 2008

(51) Int. Cl. G08B 23/00

(52) U.S. Cl. 340/573.1

(57) ABSTRACT

There is provided an identification band configured to be associated with a wearer. The identification band comprises a first band transceiver configured to receive a first profile of the wearer; a memory configured to store the first profile; and a sentinel circuit configured to detect removal of the identification band from the wearer and to detect reattachment of the identification band; wherein the identification band configured to dissociate from the wearer if the sentinel circuit detects removal of the identification band from the wearer, the identification band further configured to re-associate to the wearer if the sentinel circuit detects reattachment of the identification band. The identification band may dissociate from the wearer by invalidating the first profile stored in the memory, and the identification band may re-associate to the wearer upon receiving a second profile that uniquely identifies the first profile.

### BACKGROUND OF THE INVENTION

1. Field of the Invention

The present invention is generally in the field of communication. More particularly, the present invention relates to identification and authentication.

2. Background Art

Entertainment venues rely upon a limited set of conventional means for managing guest transactions. One such means is the ubiquitous paper ticket; and another such means is the widespread plastic wristband. A paper ticket, for example, may be typically issued to a guest of a movie theater entertainment venue with the expectation that the guest will maintain possession of the paper ticket for the duration of a movie showing. Thus, a movie theater attendant may ask an apparent guest inside the theater for his ticket to verify an entitlement to attendance. In a similar vein, a plastic wristband, for example, may be typically issued to a guest of a music concert entertainment venue with the expectation that the guest will wear the plastic wristband while at the concert to indicate an entitlement. Thus, concert security personnel may observe a guest's wristband before allowing him into a restricted or privileged area, such as a backstage area.

These various conventional means for managing guest transactions have assorted drawbacks. For example, plastic wristbands, if easily transferable, can pass from guest to guest for re-use, often against the policy of an entertainment venue. For example, a first guest may benefit from a wristband inside a music concert, leave the concert, and transfer the wristband to a second guest who enters the concert and benefits from the wristband, without paying the venue's wristband fee. One solution to this exemplary problem is to render such wristbands inoperable or disabled after removal from the first guest, but such a solution requires continuous wearing of the wristband by the first guest, which may lead to discomfort or inconvenience.

Accordingly, there is a need to overcome the drawbacks and deficiencies in the art by offering an improved identification band for association to a wearer.

### SUMMARY OF THE INVENTION

An identification band with secured association to the wearer, substantially as shown in and/or described in connection with at least one of the figures, and as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an exemplary identification band with secured association to the wearer, according to one embodiment of the present invention;

FIG. 2 shows a diagram of an exemplary system including an identification band with secured association to the wearer, according to one embodiment of the present invention; and

FIG. 3 is a flowchart presenting a method for secured association of an identification band to a wearer, according to one embodiment of the present invention.

### DETAILED DESCRIPTION OF THE INVENTION

The present invention is directed to securely associating an identification band to a wearer. Although the invention is described with respect to specific embodiments, the principles of the invention, as defined by the claims appended herein, can obviously be applied beyond the specific embodiments of the invention described herein. Moreover, in the description of the present invention, certain details have been left out in order to not obscure the inventive aspects of the invention. The details left out are within the knowledge of a person of ordinary skill in the art. The drawings in the present application and their accompanying detailed description are directed to merely exemplary embodiments of the invention. To maintain brevity, other embodiments of the invention, which use the principles of the present invention are not specifically described in the present application and are not specifically illustrated by the present drawings.

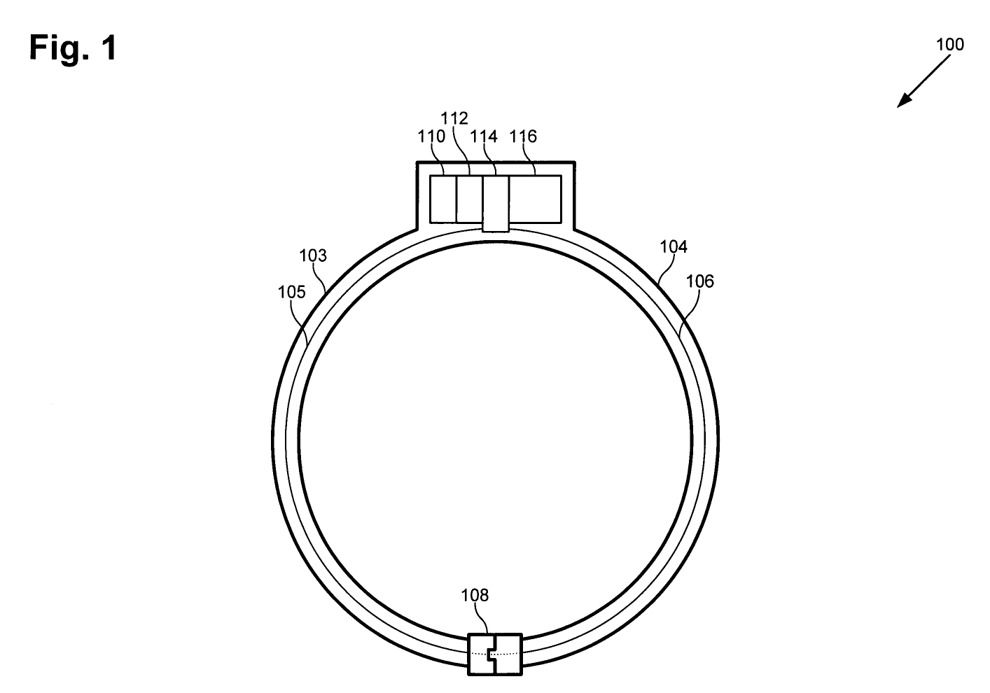

FIG. 1 shows exemplary identification band 100 according to one embodiment of the present invention. Identification band 100 may be utilized to perform, for example, entitlement transactions and identity transactions in an entertainment venue. Identification band 100 comprises strap 103, strap 104, wire 105, wire 106, and conductive clasp 108. Identification band 100 also comprises first band transceiver 110, second band transceiver 112, sentinel circuit 114, and memory 116, which may be implemented as, for example, one or more integrated circuits inside identification band 100. As shown in FIG. 1, wire 105 is encased or embedded in strap 103 and is coupled to sentinel circuit 114 and conductive clasp 108. Similarly, wire 106 is encased or embedded in strap 104 and is also coupled to sentinel circuit 114 and conductive clasp 108. First band transceiver 110 is configured to receive a first profile of a wearer to associate identification band 100 to the wearer as discussed further below.

Identification band 100 is designed in one embodiment as a wristband to be worn on a wrist of the wearer, and may be sized, for example, to fit the wrist of a child or of an adult. In another embodiment, identification band 100 may be designed as a necklace, for example, or another item of adornment instead of as a wristband. Identification band 100 is shown in FIG. 1 with conductive clasp 108 joined, and conductive clasp 108 can be disconnected into two parts (e.g., male and female connector parts), thereby allowing identification band 100 to be attached to, removed from, and reattached to a wrist of the wearer. In the present embodiment, the lengths of straps 103 and 104 are short enough that when conductive clasp 108 is joined, identification band 100 fits snugly or tightly enough on a wrist of the wearer to avoid slipping off.

Wires 105 and 106 are, in one embodiment, electrically conducting wires that comprise a closed circuit through conductive clasp 108 when conductive clasp 108 is joined, and that form an open circuit when conductive clasp 108 is disconnected. Sentinel circuit 114 is configured to monitor the conductivity of wires 105 and 106, as known in the art, to determine whether conductive clasp 108 is joined or disconnected. In one embodiment, sentinel circuit 114 is additionally configured to detect attempts to splice wires 105 and 106 with an additional wire by monitoring wires 105 and 106 for changes in resistivity. Sentinel circuit 114 thus may thus determine when identification band 100 is attached or removed from a wrist of the wearer, and may also identify attempts to tamper with identification band 100.

Identification band 100 is associated to the wearer by storing a first profile of the wearer in memory 116. When sentinel circuit 114 detects that conductive clasp 108 has been joined (e.g., when the wearer puts identification band 100 on his wrist), identification band 100 examines memory 116 to determine if the first profile has previously been stored. If so, identification band 100 proceeds with an attempt to re-associate to the wearer, as described further below. However, if there is no first profile stored in memory 116, identification band 100 is configured to receive the first profile via first band transceiver 110. In one embodiment, the first profile is a biometric generated from, for example, a fingerprint scanner. The first profile received by first band transceiver 110 during association may be, for example, a digital representation of a fingerprint, or a checksum generated from a fingerprint. In another embodiment, the first profile is generated from a different type of biometric scanner or sensor, such as, for example, an eye scanner or a facial recognition scanner. In further embodiments, the first profile may comprise nonbiometric information, such as a PIN (“Personal Identification Number”) entered on a keypad by the wearer.

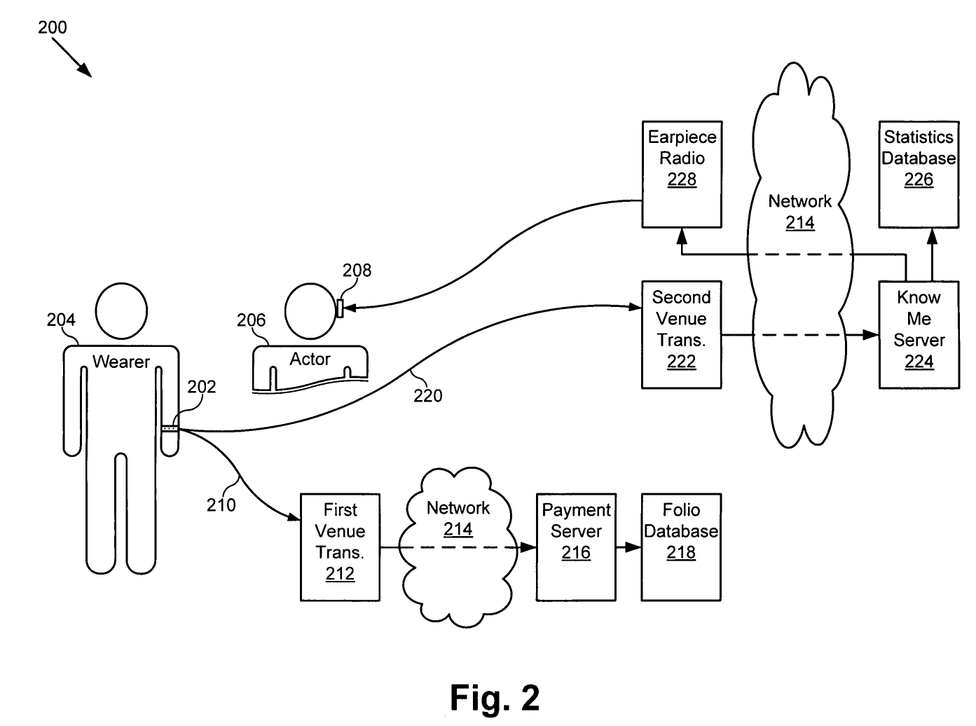

After association of the wearer and identification band 100, the wearer may utilize identification band 100 to perform various transactions in the entertainment venue. In one embodiment, first band transceiver 110 is configured to perform entitlement transactions, while second band transceiver 112 is configured to perform identity transactions. In another embodiment, first band transceiver 110 is configured to perform both entitlement and identity transactions, and in such an embodiment second band transceiver 112 may be omitted. Such transactions are depicted as transactions 210 and 220 in FIG. 2, and are described in greater detail below. After utilizing identification band 100 to perform such transactions, the wearer may disconnect conductive clasp 108 and remove identification band 100 from his wrist. The wearer may wish to do so, for example, when leaving the entertainment venue with an intent to return at a later time. When sentinel circuit 114 detects that conductive clasp 108 has been disconnected, identification band 100 dissociates from the wearer by invalidating the first profile stored in memory 116. Subsequent attempts to utilize identification band 100 to perform various transactions will fail until identification band 100 is re-associated to the wearer.

Identification band 100 is re-associated to the wearer by reattaching identification band 100 to a wrist of the wearer. When sentinel circuit 114 detects that conductive clasp 108 has been rejoined, identification band 100 examines memory 116 and determines that the first profile, previously stored, has been invalidated. Identification band 100 thus attempts to receive a second profile via first band transceiver 110. If the second profile uniquely identifies the first profile stored in memory 116, the first profile is validated. For example, in one embodiment the first profile, previously invalidated, is stored in memory 116 as a digital representation of a fingerprint with an invalid flag bit, and the second profile that uniquely identifies the first profile is a matching digital representation of the same fingerprint, generated during the reattachment and re-association. In another embodiment in which there are two wearers (e.g., a group of authorized wearers), the second profile that uniquely identifies the first profile may be a digital representation of a fingerprint of a second wearer who received a second identification band as part of a group purchase transaction with a first wearer (in such an embodiment, the second wearer has taken (either deliberately or inadvertently) identification band 100 from the first wearer, and may utilize identification band 100 because the first and second wearers may each re-associate with identification band 100). After re-association of the wearer and identification band 100, the wearer may resume utilizing identification band 100 to perform various transactions in the entertainment venue.

In one embodiment, during the association described above, the first profile along with a unique band identifier of identification band 100 are stored on a networked server (not shown) of the entertainment venue. Thus the first profile is stored in a second location (i.e. the networked server) in addition to being stored in memory 116. In such an embodiment, during dissociation of identification band 100 from the wearer, the first profile stored in memory 116 may be invalidated by, for example, outright deletion instead of, for example, setting an invalid flag bit. Identification band 100 can thus be subsequently re-associated to the wearer if the second profile and the unique band identifier of identification band 100 uniquely identify (e.g. match) the first profile and unique band identifier previously stored on the networked server of the entertainment venue.

FIG. 2 shows exemplary system 200 according to one embodiment of the present invention. System 200 comprises wearer 204 and identification band 202, the latter corresponding to identification band 100 in FIG. 1. Identification band 202 is configured to engage in entitlement transaction 210 by utilizing a first band transceiver corresponding to first band transceiver 110, and to engage in identity transaction 220 by utilizing a second band transceiver corresponding to second band transceiver 112. In one embodiment, a single band transceiver, e.g. first band transceiver 110, may be utilized to engage in both entitlement transaction 210 and identity transaction 220. System 200 also comprises first venue transceiver 212, payment server 216, and folio database 218, which are utilized during entitlement transaction 210. Furthermore, system 200 comprises second venue transceiver 222, know-me server 224, statistics database 226, earpiece radio 228, and earpiece 208 (worn by actor 206), which are utilized during identity transaction 220. Network 214 is utilized for communication by various components of system 200 during entitlement transaction 210 and identity transaction 220.

In system 200, identification band 202 has been associated to wearer 204 by storing a first profile of wearer 204 in a memory of identification band 202. Identification band 202 received the first profile via a first band transceiver from first venue transceiver 212, prior to entitlement transaction 210. In one embodiment of the invention, the first profile is a biometric generated from, for example, a fingerprint scanner (not shown) coupled to first venue transceiver 212. The first profile received by the first band transceiver of identification band 202 during association was, for example, a digital representation of a fingerprint, or a checksum generated from a fingerprint. Having been thus associated to wearer 204, identification band 202 can be utilized during entitlement transaction 210.

In one embodiment of the present invention, entitlement transaction 210 is a payment transaction. In another embodiment, entitlement transaction 210 could be another form of entitlement transaction such as, for example, an entitlement transaction wherein identification band 202 operates as a room key, or wherein identification band 202 decrements a multi-day parking ticket or facilitates single-use entrance to an entertainment or sporting event. In one embodiment, the first band transceiver of identification band 202 is implemented as a payment transceiver by utilizing, for example, a MIFARE chip or another short-range, secure transceiver. Thus implemented, wearer 204 can utilize identification band 202 to purchase, for example, refreshments at a concession stand by presenting identification band 202 to first venue transceiver 212, which in this example also comprises a MIFARE chip. First venue transceiver 212 communicates a purchase request to payment server 216 via network 214. In the present embodiment, payment server 216 can look up a payment account in folio database 218 based on the first profile stored in identification band 202, and record the payment transaction in folio database 218, to be later paid by wearer 204. In another embodiment, payment server can, for example, instead make a charge to a credit card based on the first profile stored in identification band 202.

In addition to entitlement transaction 210, wearer 204 may also utilize identification band 202 to engage in identity transaction 220. Identity transaction 220 is not an entitlement transaction characterized by, for example, exercising a right of wearer 204 or making a purchase for wearer 204. Instead, identity transaction 220 is an identity-based or “know-me” transaction characterized by, for example, personalizing an aspect of an entertainment venue for wearer 204, or for collecting data about wearer 204. Identity transaction 220 is thus based, in one embodiment, on the identity of wearer 204, and not on an entitlement of wearer 204. In identity transaction 220, the second band transceiver of identification band 202 is implemented as, for example, an RFID chip, and transmits the name of wearer 204, stored in the memory of identification band 202 with, or in, a first profile, to second venue transceiver 222. Second venue transceiver 222 transmits the name of wearer 204 to know-me server 224 via network 214, and know-me server 224 may complete identity transaction 220 by performing several exemplary functions with the name of wearer 204.

In one such exemplary function, know-me server 224 transmits an identifier of wearer 204 such as the name of wearer 204 to statistics database 226, a collection of statistical data, to complete identity transaction 220. In particular, in an entertainment venue having a queue for a rollercoaster ride, second venue transceiver 222 can gather the identities (e.g. names) of guests in the queue, including wearer 204. Thus, statistical data about which guests waited for the ride, and how long each guest waited for the ride, can be gathered by statistics database 226. In a second exemplary function, know-me server 224 can transmit an identifier (e.g. name) of wearer 204 to earpiece radio 228 via network 214, and earpiece radio 228 can transmit the identifier of wearer 204 to actor 206 via wireless earpiece 208, to complete identity transaction 220. Actor 206 can be, for example, an actor playing a character in a theme park. From earpiece 208, actor 206 can unobtrusively learn, for example, the name of wearer 204, and can thus interact with wearer 204 in a more personable or entertaining manner.

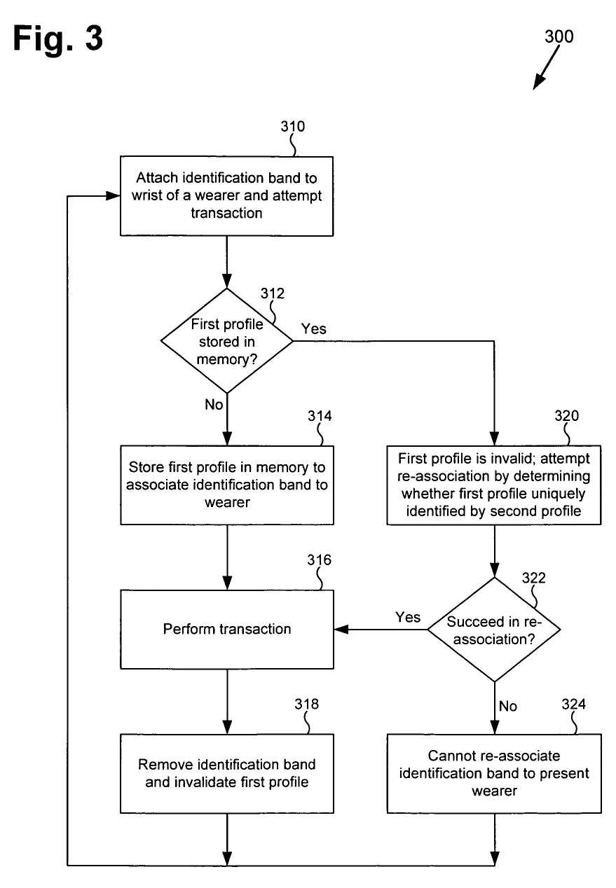

FIG. 3 shows flowchart 300 of an exemplary method for associating an identification band to a wearer, according to one embodiment of the present invention. Certain details and features have been left out of flowchart 300 that are apparent to a person of ordinary skill in the art. For example, a step may comprise one or more substeps or may involve specialized equipment or materials, as known in the art. While steps 310 through 324 indicated in flowchart 300 are sufficient to describe one embodiment of the present invention, other embodiments of the invention may utilize steps different from those shown in flowchart 300.

In step 310 of flowchart 300, an identification band, for example identification band 202 in FIG. 2, is attached to the wrist of a wearer such as wearer 204. The identification band is implemented as, for example, a wristband, and has a memory corresponding to memory 116 in FIG. 1 and a first band transceiver corresponding to first band transceiver 110. The identification band additionally has a sentinel circuit corresponding to sentinel circuit 114. In the present example, the identification band has not previously been associated with a wearer, and after attaching the identification band the wearer attempts an entitlement transaction by, for example, utilizing the identification band in a purchase transaction.

In step 312 of flowchart 300, the identification band determines whether a first profile is stored in the memory. Because the identification band has not previously been associated with a wearer, a first profile is not so stored, and the wearer must provide a first profile (e.g., present a biometric such as a fingerprint to a scanner, or enter a PIN on a keypad) in step 314 of flowchart 300. The wearer thus provides a first profile that is stored in the memory of the identification band after being transmitted to the identification band by a first venue transceiver corresponding, for example, to first venue transceiver 212. The identification band is thereby associated to the wearer, and the identification band can thus be utilized to complete the entitlement transaction in step 316.

In step 318 of flowchart 300, after associating the identification band and utilizing the identification band to perform an entitlement transaction in steps 310 through 316, the wearer removes the identification band. The wearer may do so, for example, after leaving an entertainment venue. The sentinel circuit of the identification band detects removal of the identification band by utilizing, for example, a conductive clasp such as conductive clasp 108 in FIG. 1. The identification band then invalidates the first profile by, for example, setting an invalid flag bit, and the identification band is thereby dissociated from the wearer.

Subsequently, step 310 of flowchart 300 is repeated, as shown in FIG. 3. In repeating step 310 with the identification band of step 318 discussed above, i.e. the identification band storing an invalidated first profile, a different path through flowchart may be followed. In particular, in the present example, the identification band has previously been associated with a wearer. Thus, after attaching the identification band and attempting an entitlement transaction, the outcome of step 312 will be different.

In step 312 of flowchart 300, the first venue transceiver determines that the first profile is stored in the memory of the identification band, but is invalid. Because the identification band has previously been associated with a wearer, the wearer is prompted to provide a second profile (e.g., again present a biometric such as a fingerprint to a scanner) in step 320 of flowchart 300. The wearer thus provides a second profile that is compared to the invalidated first profile stored in the memory of the identification band. In step 322, if the second profile uniquely identifies (e.g., matches) the first profile, the identification band is successfully re-associated to the wearer, and flowchart 300 proceeds to and repeats steps 316 and 318.

If the second profile does not uniquely identify the first profile, the identification band is not successfully re-associated to the wearer. Thus, flowchart 300 proceeds from step 322 to 324, instead of returning to step 316. This may occur when, for example, the wearer attempting to re-associate with the identification band is not the same wearer who originally associated with the identification band. In step 324, the wearer cannot complete an entitlement transaction, and must return to step 310 and, for example, return the identification band to the correct wearer.

In the manner described above, the invention as shown in exemplary identification band 100, exemplary system 200, and exemplary flowchart 300 achieves secure association of an identification band to a wearer and overcomes the drawbacks of conventional solutions. Identification bands utilizing the invention may, for example, be associated, dissociated, and re-associated to wearers using novel sentinel circuits and other systems or methods as described above. The drawbacks of conventional solutions, which are, for example, less secure, are avoided.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. An identification band configured to be associated with a wearer, the identification band comprising:
a first band transceiver configured to receive a first profile of the wearer;
a memory configured to store the first profile;
a sentinel circuit configured to detect removal of the identification band from the wearer and to detect reattachment of the identification band;
wherein the identification band is configured to dissociate from the wearer if the sentinel circuit detects removal of the identification band from the wearer, the identification band further configured to re-associate to the wearer if the sentinel circuit detects reattachment of the identification band.

2. The identification band of claim 1, further configured to dissociate from the wearer by invalidating the first profile stored in the memory.

3. The identification band of claim 1, further configured to re-associate to the wearer upon receiving a second profile that uniquely identifies the first profile.

4. The identification band of claim 2, further configured to re-associate to the wearer upon receiving a second profile that uniquely identifies the first profile.

5. The identification band of claim 1, the first band transceiver further configured to perform an entitlement transaction.

6. The identification band of claim 1, the first band transceiver further configured to perform an identity transaction.

7. The identification band of claim 1, further comprising a second band transceiver configured to perform an identity transaction.

8. The identification band of claim 1, further comprising a unique band identifier.

9. The identification band of claim 1, wherein the sentinel circuit comprises a conductive clasp.

10. The identification band of claim 1, wherein the first profile comprises a biometric.

11. A system comprising:
a first venue transceiver configured to perform an entitlement transaction;
a second venue transceiver configured to perform an identity transaction;
the first venue transceiver further configured to transmit a first profile to an identification band, the identification band comprising:
a first band transceiver configured to receive a first profile of a wearer;
a memory configured to store the first profile;
a sentinel circuit configured to detect removal of the identification band from the wearer and to detect reattachment of the identification band;
wherein the identification band is configured to dissociate from the wearer if the sentinel circuit detects removal of the identification band from the wearer, the identification band further configured to re-associate to the wearer if the sentinel circuit detects reattachment of the identification band.

12. The system of claim 11, the identification band further configured to dissociate from the wearer by invalidating the first profile stored in the memory.

13. The system of claim 11, the identification band further configured to re-associate to the wearer upon receiving from the first venue transceiver a second profile that uniquely identifies the first profile.

14. The system of claim 11, the identification band further comprising a second band transceiver.

15. The system of claim 11, the identification band further comprising a unique band identifier.

16. The system of claim 11, wherein the sentinel circuit comprises a conductive clasp.

17. The system of claim 11, wherein the first profile comprises a biometric.

18. A method for use by an identification band, the method comprising:
storing a first profile received by the identification band from a first venue transceiver;
associating the identification band to a wearer using the first profile received by the identification band from the first venue transceiver;
detecting removal of the identification band from the wearer;
dissociating the identification band from the wearer in response to detecting the removal of the identification band from the wearer;
detecting reattachment of the identification band;
re-associating the identification band to the wearer in response to detecting the reattachment of the identification band.

19. The method of claim 18, wherein dissociating the identification band from the wearer comprises invalidating the first profile.

20. The method of claim 18, wherein re-associating the identification band to the wearer comprises receiving a second profile that uniquely identifies the first profile.
